(19) United States
(12) Patent Application Publication
(10) Pub. No.: US 2025/0188773 A1
(43) Pub. Date: Jun. 12, 2025

(54) HANDCUFFS FOR THE ARREST OF PERSONS

(71) Applicant: Carlos GOMEZ LLORENS, Valencia (ES)

(72) Inventor: Carlos GOMEZ LLORENS, Valencia (ES)

(21) Appl. No.: 18/844,151

(22) PCT Filed: Mar. 10, 2023
(86) PCT No.: PCT/ES2023/070134

§ 371 Date: Sep. 5, 2024

(30) Foreign Application Priority Data
Mar. 21, 2022 (ES) U202230459

(51) Int. Cl. E05B 75/00

(52) U.S. Cl. CPC E05B 75/00

(57) ABSTRACT

A wrist shackle for restraining people and essentially designed for the arrest of individuals, including two rings (1) joined together by at least two joining mechanisms (2, 3) and where each of the rings (1) includes a fixed part (1a) and a movable part (1b), each fixed part (1a) including two pawls (4) with at least two locking elements (5) and a metal plate (9) between them, as well as a safety mechanism (6) that hides a lock (7), and where each mobile part (1b) includes, in turn, a plurality of teeth (8) divided into two rows.

### PURPOSE OF THE INVENTION

The purpose of this report is a handcuff essentially designed for the restraining of individuals, which has been created with safety improvements compared to the methods already existing within the state of the art.

### Invention Background

There are currently several inventions known in the state of the art for the purpose of restraining a person during their arrest, but which contain various weak points in their design or mechanism that enable a person skilled in the art and/or with knowledge of how they work to open said handcuffs with relative ease, which poses a danger to the security forces and/or officials who are making the arrest.

The Spanish utility model ES 0 031 860 U, a handcuff characterised by a pawl and a safety rod or latch, with the pawl rotating on a pin, with constant pressure from a spring in the direction of the teeth of the swing arm, bearing a notch that, when rotating, inserts the tongue and causes the engagement of the teeth to separate from those of the swing arm.

Translated European patent ES 2 570 955 T3, safety handcuffs for facilitating their placement on an individual, comprising a first half-clamp and a second half-clamp that can be closed in a locked position around an object and opened by means of an opening mechanism that can be unlocked by a key, and at least one cuff body comprising mechanisms for locking the cuff, said first half-clamp being pivotally mounted around an axis located inside the cuff body and capable of being set in motion around said axis to thus allow said object to be grasped. Said locking mechanism comprises a mechanism for locking the cuff in the opened position secured to the cuff body and a mechanism for locking it in the closed position. Said cuff is characterised by the fact that the mechanism for locking the cuff in the opened position includes a locking notch pivotally mounted around an axis fixed to the cuff body. Said first half-clamp includes a recess in the cuff body that penetrates said locking notch, opposing a return spring, which allows said first half-clamp to be locked and to keep the cuff in the opened position, thus preventing its accidental closure and allowing a frontal grip of said object; the cuff includes an unlocking mechanism constituted from a decoupling pedal pivoting about an axis, said first half-clamp including a recess into which a lug of said locking notch has penetrated by the action of said return spring, in order to thus keep the cuff locked in the open position, a push exerted by said object on said decoupling pedal rotates said locking notch around its axis and disengages said lug from said notch and releases the second half-clamp.

This type of cuff, known in the state of the art, has a series of drawbacks related to its safety and ease of placement, being relatively easy to manipulate by users without their respective safety keys, as well as presenting a series of drawbacks in stressful situations and/or in situations of poor visibility, which makes their placement on uncooperative people difficult, forcing the user to employ greater force than usual for their proper placement.

### DESCRIPTION OF THE INVENTION

One of the objects pertaining to this invention is a wrist cuff for the arrest of persons that prevents unwanted opening by third-party individuals and facilitates placement by the police officer in charge. For this purpose, the wrist cuff for restraining people, the object of this report, comprises two rings divided into a fixed part and a mobile part joined together by means of connection mechanisms, where the fixed part of the rings is made up of two pawls with locking elements and a safety mechanism that conceals a lock and where the movable part is made up of a plurality of teeth divided into two rows.

More specifically, the wrist cuff comprises two small, partially hidden pawls in each of its fixed parts with four teeth, as well as two locking elements before the pawls and another two elements after it that permit the locking of any element that is inserted to manipulate the cuffs, and also contains a metal plate placed between them that prevents any type of possible manipulation of the system.

Thanks to its design, the safety mechanism comprises a spring and a cover that can be placed in two different positions, the first of which is configured to cover and hide the lock, and the second of which allows the movable part of the ring to be locked by placing it in the opposite direction to the first one, thus allowing the lock to only be uncovered when the user who has placed the cuffs on the detained individual so desires. This locking system allows for quick and secure placement of the shackling and prevents injuries to the individual's wrists.

On the other hand, the joining mechanism of the cuffs corresponds to a central chain and, at least, one steel cable or cable made with another material with equivalent mechanical characteristics, covered by a non-slip sheath, or another with equivalent mechanical characteristics, in a black colour that enables greater mobility to the user when placing them, avoiding the rigidity of those currently existing in the state of the art. Both the movable ring of the cuff and the cover are made of silver, which makes it easy to put them on regardless of the conditions at the time of arrest, such as light conditions, stress, etc., or when the individual is an uncooperative person.

As for size, the cuff can be made in different sizes so that it fits perfectly to the size of the user's hand, thus making it easier to grip and put on. This is possible due to the different sizes of the central chain and the cables made of steel or other material with equivalent mechanical characteristics. Likewise, the contact area of the movable ring with the user's wrist is designed with a straight shape so that it does not slip and adapts better to the user, thus allowing a good grip for the person in charge of placing it.

### BRIEF DESCRIPTION OF THE FIGURES

Below is a brief description of a number of illustrations with a view to gaining a better understanding of the invention that are explicitly related to an embodiment of this invention, presented as a non-limiting example thereof.

FIG. 1. Shows a view of the wrist cuff for restraining people.

FIG. 2. Shows a second view of the wrist cuff for restraining people.

FIG. 3. Shows an internal view of the wrist cuff for restraining people.

FIG. 4. Shows a detailed view of the locking elements (5) and the metal plate (9), part of the wrist cuff for restraining people.

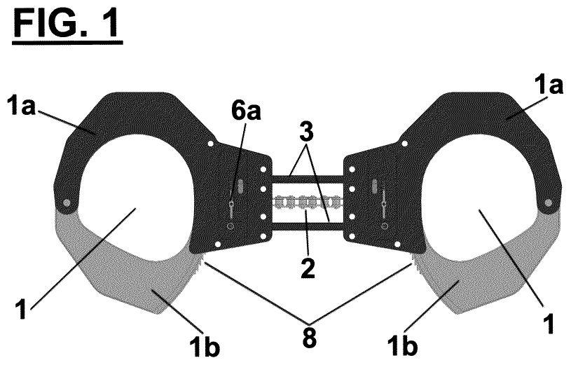

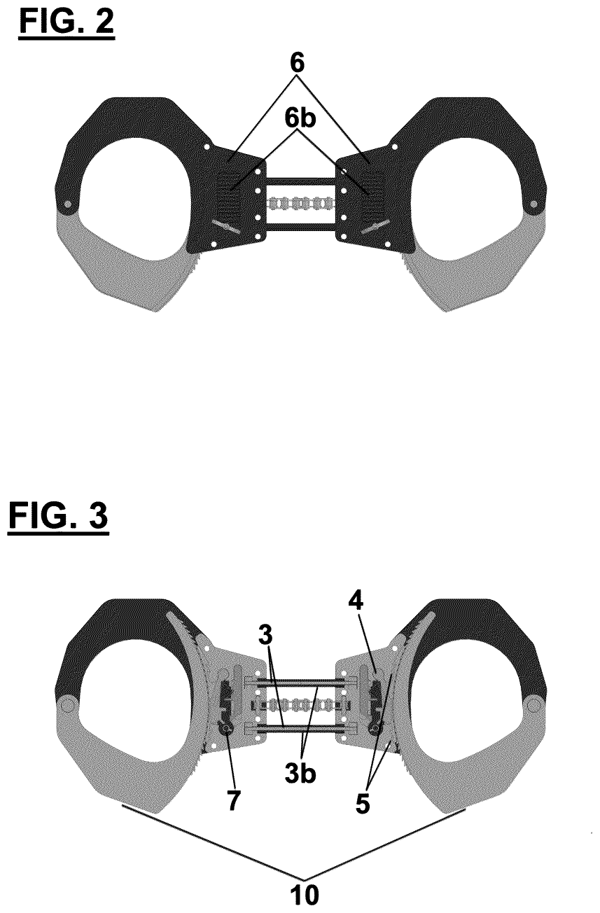

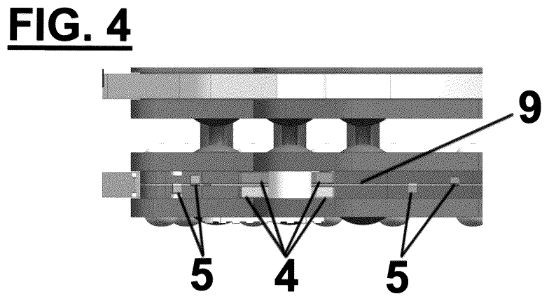

### DETAILED EXPLANATION OF HOW THE INVENTION SHOULD BE SET UP

The attached figures show a preferred embodiment of the invention. More specifically, the wrist cuff for restraining people, comprising two rings (1) joined together by at least two joining mechanisms (2, 3) and where each of the movable rings (1) comprises a fixed part (1a) and a movable part (1b) where each fixed part (1a) comprises two pawls (4) with at least two locking elements (5) and a metal plate (9) between them, as well as a safety mechanism (6) that hides a lock (7), and where the movable part (1b) comprises, in turn, a plurality of teeth (8) divided into two rows.

In a first particular embodiment, the joining mechanisms correspond to a central chain (2) and at least one steel cable (3) or cable made with another material with equivalent mechanical characteristics.

In a second particular embodiment, the steel cable (3) is covered by a non-slip sheath (3b) or another cable with equivalent mechanical characteristics.

In a third particular embodiment, the locking elements (5) are metallic and are divided into equal parts before and after the pawls (4).

In a third particular embodiment, the safety mechanism (6) comprises a spring (6a) and a cover (6b).

In a fourth particular embodiment, the cover (6b) can be placed in two positions configured to cover and hide the lock (7), the first of them, and to lock the movable part (1b) of the ring (1) by placing it in the opposite direction to the first of them.

In a first preferred embodiment, the contact area (10) of the rings (1) with the user's wrist is flat

What is claimed is:

1. A wrist cuff for restraining people comprising:
two rings joined together by at least two joining mechanisms and where each of the rings comprises a fixed part and a movable part,
wherein each fixed part comprises:
two pawls with at least two locking elements and a metal plate between them, as well as and a safety mechanism that hides a lock, and
wherein each movable part comprises, in turn, a plurality of teeth divided into two rows.

2. A wrist cuff according to claim 1,
wherein the joining mechanisms include a central chain and, at least one cable made of one of steel or another material with equivalent mechanical characteristics.

3. A wrist cuff according to claim 1, wherein the at least one cable is covered by one of a non-slip sheath or another cable with equivalent mechanical characteristics.

4. A wrist cuff according to claim 1, wherein the locking elements are metallic and are divided into equal parts before and after the pawls.

5. A wrist cuff according to claim 1, wherein the safety mechanism comprises a spring and a cover.

6. A wrist cuff according to claim 1, wherein the cover is adapted to be placed in two positions configured to cover and hide the lock, the first of them, and to lock the movable part of the ring by placing it in the opposite direction to the first of them.

7. A wrist cuff according to claim 1, wherein the contact area of the rings with the user's wrist is flat.
